(19) United States
(12) Patent Application Publication
(10) Pub. No.: US 2026/0103415 A1
(43) Pub. Date: Apr. 16, 2026

(54) SYSTEMS AND METHODS FOR WASTEWATER TREATMENT

(71) Applicant: Advanced Drainage Systems, Inc., Hilliard, OH (US)

(72) Inventors: Emmy RADICH, Old Saybrook, CT (US); Bryan COPPES, Old Saybrook, CT (US); Adam MILLER, New York, NY (US)

(73) Assignee: Advanced Drainage Systems, Inc., Hilliard, OH (US)

(21) Appl. No.: 19/356,368

(22) Filed: Oct. 13, 2025

Related U.S. Application Data
(60) Provisional application No. 63/706,088, filed on Oct. 11, 2024.

(51) Int. Cl. C02F 9/00; C02F 3/30; C02F 101/16

(52) U.S. Cl. CPC C02F 9/00; C02F 3/303; C02F 3/305; C02F 2101/163; C02F 2201/004; C02F 2203/006

(57) ABSTRACT

Disclosed embodiments relate to a water treatment unit for use in a water treatment system. In some embodiments, the water treatment unit may comprise a hollow unit forming an interior volume, a first divider and a second divider, wherein the first divider and the second divider may divide the interior volume into a first compartment, a second compartment, a third compartment and a fourth compartment, an aeration grid, wherein the aeration grid may release oxygen into the interior volume, an aeration grid pipe, wherein the aeration grid pipe may supply oxygen to the aeration grid, and an air lift system, wherein the air lift system may recirculate water within the water treatment system.

### CROSS REFERENCE TO RELATED APPLICATIONS

This application claims the benefit of priority of U.S. Provisional Application No. 63/706,088, filed on Oct. 11, 2024, the contents of which are incorporated herein by reference in their entirety

### TECHNICAL FIELD

This disclosure relates generally to systems, methods, and apparatuses for treating wastewater through a wastewater treatment system, and more particularly, for treating wastewater through an on-site wastewater treatment unit including an aeration grid.

### BACKGROUND

Wastewater from a residential or commercial building may often be treated by an onsite subsurface wastewater treatment system. The onsite subsurface wastewater treatment system may comprise a primary tank that may receive the flow of wastewater from a source in the residential or commercial building. Residuals may settle out of the flow of wastewater and remain in the primary tank while the wastewater flows from the primary tank to a septic tank. A wastewater treatment unit with an aeration grid may be provided in the septic tank. The wastewater treatment unit may facilitate nitrification of the wastewater through the use of an aeration grid. Denitrification may also occur in the anoxic area of the septic tank to further treat the wastewater. The treated wastewater may then flow through a discharge assembly to a dispersal system.

Existing wastewater treatment systems may utilize an aeration process to reduce nitrogen pollutants such as ammonia and nitrate, biochemical oxygen demand (BOD), and total suspended solids (TSS) from the wastewater flowing through the system. Such existing wastewater treatment systems may include an aeration system designed to release oxygen directly into the wastewater to promote aerobic biodegradation. Adding oxygen into the wastewater may increase aerobic activity and encourage microbial growth in the wastewater. The microbes may then biologically degrade suspended solids or dissolved organic matter in the wastewater. The suspended solids may then settle out of the wastewater into a sludge at the bottom of the septic tank.

However, solutions are needed to improve the reduction of BOD, TSS, and nitrogen pollutants from wastewater while providing a compact wastewater treatment system. Such solutions should provide a wastewater treatment system with a wastewater treatment unit including an aeration grid to improve the reduction of BOD, TSS, and other pollutants in the flow of wastewater. Such solutions should provide a wastewater treatment system that may be divided into a first compartment and a second compartment by a baffle. The first compartment may allow for solids and other pollutants to settle out of the flow of wastewater. The second compartment may contain a wastewater treatment unit that may include an aeration grid. The wastewater treatment unit may be divided into four compartments to improve the reduction of pollutants in the flow of wastewater by providing multiple treatment areas within one compact wastewater treatment unit. The wastewater treatment system may further include components that may be compactly stacked for storage and transportation and may be easily assembled on site.

### SUMMARY

The disclosed embodiments describe systems, methods, and devices for treating wastewater through a wastewater treatment system, and more particularly, for treating wastewater through an on-site wastewater treatment unit including an aeration grid. These systems, methods, and devices may include a water treatment unit for use in a water treatment system. The water treatment unit may comprise: a hollow unit forming an interior volume, a first divider and a second divider, wherein the first divider and the second divider may divide the interior volume into a first compartment, a second compartment, a third compartment and a fourth compartment, an aeration grid, wherein the aeration grid may release oxygen into the interior volume, an aeration grid pipe, wherein the aeration grid pipe may supply oxygen to the aeration grid, and an air lift system, wherein the air lift system may recirculate water within the water treatment system.

In some embodiments, the hollow unit may comprise a first half unit and a second half unit mated at a joint. In some embodiments, the first half unit and the second half unit may be identical. In other embodiments, the first half unit may comprise a mesh top surface and the second half unit may comprise a mesh bottom surface. In some embodiments, the first half unit may further comprise a saddle, wherein the saddle may support an outflow pipe and a gasket on the saddle, wherein the gasket may provide a watertight connection between the saddle and the outflow pipe. In some embodiments, the first half unit and the second half unit may further comprise a plurality of divider supports, wherein the plurality of divider supports may secure the first divider and the second divider within the interior volume. In other embodiments, the first half unit and the second half unit may further comprise a plurality of pipe supports, wherein the plurality of pipe supports may secure the aeration grid pipe and the air lift system. In some embodiments, the first half unit and the second half unit may further comprise a first mesh opening associated with the second compartment, wherein the first mesh opening may allow an outflow of water from the second compartment and a second mesh opening associated with the third compartment, wherein the second mesh opening may allow an inflow of water into the third compartment. In some embodiments, the first divider may comprise a plurality of openings between the first compartment and the second compartment and an opening between the third compartment and the fourth compartment.

In some embodiments, the first compartment may comprise an open compartment containing a biofilm, wherein the biofilm may treat a flow of water through the first compartment. In other embodiments, the second compartment may comprise an open compartment containing a biofilm, wherein the biofilm may treat a flow of water through the second compartment. In some embodiments, the fourth compartment may comprise an open compartment to retain a flow of treated water. In some embodiments, the fourth compartment may further comprise an outflow pipe, wherein the outflow pipe may remove the flow of treated water from the wastewater treatment unit.

In some embodiments, the third compartment may comprise a fixed bed biological reactor (FBBR) system, wherein the FBBR system may polish water within the third compartment, which specifically involves further reduction of BOD, TSS, and nitrogen pollutants. In other embodiments, the FBBR system may comprise a first plurality of media blocks and a second plurality of media blocks separated by a baffle. In some embodiments, the baffle may comprise a solid divider between the first plurality of media blocks and the second plurality of media blocks and an opening at a top portion of the baffle. In other embodiments a flow of water may flow upwardly through the first plurality of media blocks, through the opening at the top portion of the baffle, and downwardly through the second plurality of media blocks. In some embodiments, the first plurality of media blocks and the second plurality of media blocks may each comprise 12 media blocks. In other embodiments, a media block from the first plurality of media blocks may comprise: a base, a plurality of media extensions extending upwardly from the base, a plurality of connectors connecting the plurality of media extensions, at least one snap connector extending upwardly from the base, at least one open connector extending upwardly from the base, at least one snap connector extending downwardly from the base, and at least one open connector extending downwardly from the base.

In some embodiments, the aeration grid may comprise: a cover, wherein the cover may comprise: a plurality of holes to release oxygen into the water treatment unit, a plurality of slots, wherein the plurality of slots may secure the first divider and the second divider, and a plurality of indentations, wherein the plurality of indentations may secure the aeration grid pipe and the air lift system. The aeration grid may further comprise a base, wherein the base may comprise: a plurality of channels spaced between a plurality of compartments, wherein the plurality of channels may distribute oxygen throughout the base. In some embodiments, the base may further comprise a filler material within the plurality of compartments.

In some embodiments, the water treatment unit may further comprise: an air compressor, a supply pipe connected to the air compressor, and a tee fitting connected to the supply pipe, wherein the tee fitting may further connect to the air lift system and the aeration grid pipe. In some embodiments, the air lift system may comprise: an interior pipe connected to the tee fitting, wherein the interior pipe may direct oxygen downwardly and an exterior pipe surrounding the interior pipe, wherein the exterior pipe may direct a mixture of oxygen and water upwardly. In other embodiments, the interior pipe may comprise a plurality of openings at a lower portion of the interior pipe, wherein the plurality of openings may release oxygen from the interior pipe. In some embodiments, the plurality of openings may comprise three openings. In other embodiments, the interior pipe may extend further downwardly than the exterior pipe. In some embodiments, the exterior pipe may connect to a recirculation tee fitting to recirculate the mixture of oxygen and water within the wastewater treatment system.

The disclosed embodiments may further include a water treatment unit for use in a water treatment system. The water treatment unit may comprise a hollow unit forming an interior volume, a first divider and a second divider, wherein the first divider and the second divider may be configured to divide the interior volume into a first compartment, a second compartment, a third compartment, and a fourth compartment, the first compartment comprising a first open compartment containing a first biofilm, the second compartment comprising a second open compartment containing a second biofilm, the third compartment comprising a fixed bed biological reactor (FBBR) system, and the fourth compartment comprising a third open compartment to retain a flow of treated water.

The disclosed embodiments may further include a water treatment unit for use in a water treatment system. The water treatment unit may comprise a hollow unit forming an interior volume, a first divider and a second divider, wherein the first divider and the second divider may be configured to divide the interior volume into a first compartment, a second compartment, a third compartment, and a fourth compartment, an aeration grid, wherein the aeration grid may release oxygen into the interior volume, and an aeration grid pipe, wherein the aeration grid pipe may supply oxygen to the aeration grid.

The disclosed embodiments may further include a water treatment unit for use in a water treatment system. The water treatment unit may comprise a hollow unit forming an interior volume, a first divider and a second divider, wherein the first divider and the second divider may be configured to divide the interior volume into a first compartment, a second compartment, a third compartment, and a fourth compartment, an aeration grid, wherein the aeration grid may release oxygen into the interior volume, and an air lift system, wherein the air lift system may recirculate water within the water treatment system.

The disclosed embodiments may further include a method of treating a flow of wastewater through a water treatment system. The method may comprise receiving, within a first chamber of the water treatment system the flow of wastewater from a source, directing the flow of wastewater from the first chamber of the water treatment system into a first compartment of a water treatment unit located in a second chamber of the water treatment system, directing the flow of wastewater through a plurality of openings in a divider into a second compartment of the water treatment unit, directing the flow of wastewater out of the second compartment of the water treatment unit and into the second chamber of the water treatment system through a first opening in the water treatment unit, directing the flow of wastewater from the second chamber of the water treatment system into a third compartment of the water treatment unit through a second opening in the water treatment unit, directing the flow of wastewater through an opening in the divider from the third compartment of the water treatment unit to a fourth compartment of the water treatment unit, and directing the flow of wastewater to an outlet from the fourth compartment.

In some embodiments, the method may further comprise directing the flow of wastewater upwardly through a first FBBR system in the third compartment, and directing the flow of wastewater downwardly through a second FBBR system in the third compartment. In some embodiments, the first compartment may comprise an open compartment containing a biofilm. In some embodiments, the second compartment may comprise an open compartment containing a biofilm. In some embodiments, the fourth compartment may comprise an open compartment to retain treated water. In some embodiments, the outlet may comprise an outflow pipe, wherein the outflow pipe may be configured to remove treated water from the water treatment unit. In some embodiments, directing the flow of wastewater upwardly through a first FBBR system may comprise forcing the flow of wastewater upwardly through forced air from an aeration grid. In some embodiments, directing the flow of wastewater downwardly through a second FBBR system may comprise using gravity to direct the flow of wastewater downwardly. In some embodiments, the third compartment may further comprise a baffle located between the first FBBR system and the second FBBR system.

The disclosed embodiments may further include a water treatment unit for treating a flow of wastewater. The water treatment unit may comprise a first divider and a second divider, wherein the first divider and the second divider may be configured to divide an interior volume of the water treatment unit into a first compartment, a second compartment, a third compartment, and a fourth compartment, the first compartment containing a first biofilm, wherein the first compartment may be configured to move the flow of wastewater through a plurality of openings in the first divider to the second compartment, the second compartment containing a second biofilm, wherein the second compartment may be configured to move the flow of wastewater through a first mesh opening in the water treatment unit, the third compartment containing at least one FBBR system, wherein the third compartment may be configured to accept the flow of wastewater through a second mesh opening in the water treatment unit and to move the flow of wastewater through an opening in the first divider to the fourth compartment, and the fourth compartment including an outflow pipe configured to remove treated water from the water treatment unit.

Additional features and advantages of the disclosed embodiments will be set forth in part in the description that follows, and in part will be obvious from the description, or may be learned by practice of the disclosed embodiments.

It is to be understood that both the foregoing general description and the following detailed description are examples and explanatory only and are not restrictive of the disclosed embodiments.

The accompanying drawings constitute a part of this specification. The drawings illustrate several embodiments of the present disclosure and, together with the description, serve to explain the principles of the disclosed embodiments.

### BRIEF DESCRIPTION OF THE DRAWINGS

FIG. 1 depicts a perspective view of a wastewater treatment system, consistent with embodiments of the present disclosure.

FIG. 2A depicts a perspective view of a wastewater treatment system with the top half tank removed, consistent with embodiments of the present disclosure.

FIG. 2B depicts a flow of wastewater through the wastewater treatment system of FIG. 1, consistent with embodiments of the present disclosure.

FIG. 3 depicts a perspective view of a wastewater treatment unit, consistent with embodiments of the present disclosure.

FIG. 4A depicts an interior of a wastewater treatment unit, including a first compartment, a second compartment, a third compartment, and a fourth compartment, consistent with embodiments of the present disclosure.

FIG. 4B depicts a second compartment of a wastewater treatment unit, consistent with embodiments of the present disclosure.

FIG. 4C depicts a third compartment of a wastewater treatment unit, consistent with embodiments of the present disclosure.

FIG. 4D depicts a second compartment and a fourth compartment of a wastewater treatment unit, consistent with embodiments of the present disclosure.

FIG. 5 depicts a fixed bed biological reactor system for use in a wastewater treatment unit, consistent with embodiments of the present disclosure.

FIG. 6 depicts a perspective view of a side of a media block with media extensions extending from a base for use in a fixed bed biological reactor system, consistent with embodiments of the present disclosure.

FIG. 7 depicts a top view of a media block for use in a fixed bed biological reactor system, consistent with embodiments of the present disclosure.

FIG. 8A depicts an enlarged view of a snap connector, consistent with embodiments of the present disclosure.

FIG. 8B depicts an enlarged view of an open connector, consistent with embodiments of the present disclosure.

FIG. 9 depicts a view of a flat side of a media block for use in a fixed bed biological reactor system, consistent with embodiments of the present disclosure.

FIG. 10A depicts an enlarged view of a snap connector, consistent with embodiments of the present disclosure.

FIG. 10B depicts an enlarged view of an open connector, consistent with embodiments of the present disclosure.

FIG. 11 depicts an aeration grid for use with a wastewater treatment unit, consistent with embodiments of the present disclosure.

FIG. 12 depicts an aeration grid base for use with a wastewater treatment unit, consistent with embodiments of the present disclosure.

FIG. 13 depicts an aeration and recirculation system for use with a wastewater treatment unit, consistent with embodiments of the present disclosure.

FIG. 14 depicts a section cut of a recirculation system for use with a wastewater treatment unit, consistent with embodiments of the present disclosure.

FIG. 15 depicts an aeration and recirculation system within a wastewater treatment system, consistent with embodiments of the present disclosure.

### DETAILED DESCRIPTION

Examples of embodiments of the present disclosure are described with reference to the accompanying drawings. In the figures, which are not necessarily drawn to scale, wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It should also be noted that as used in the present disclosure and in the appended claims, the singular forms “a,” “an,” and “the” include plural references unless the context clearly dictates otherwise.

The disclosed embodiments improve deficiencies in existing wastewater treatment systems by providing a system that reduces BOD, TSS, and nitrogen pollutants, from wastewater through the use of a wastewater treatment unit including an aeration grid. For example, the disclosed embodiments improve deficiencies in existing wastewater treatment systems by providing compartments within the wastewater treatment unit to provide additional filtration of the wastewater within the wastewater treatment unit. The disclosed embodiments may further improve deficiencies in existing wastewater treatment systems by providing a system that is compact, easy to assemble, and requires minimal maintenance. The disclosed embodiments may further provide a wastewater treatment system with components that may be efficiently stacked for storage and transportation.

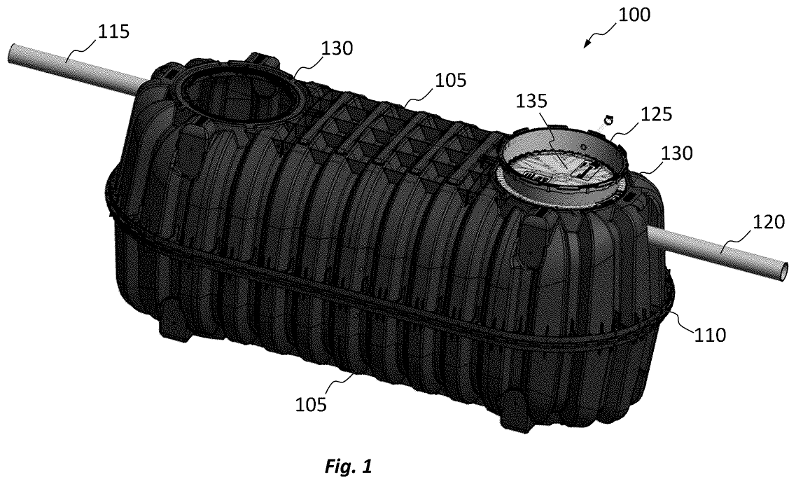

FIG. 1A depicts a wastewater treatment system 100, consistent with disclosed embodiments. Wastewater treatment system 100 may comprise a system for removing contaminants from a flow of wastewater, as disclosed herein. Wastewater treatment system 100 may include two identical half tanks 105. Half tanks 105 may be mated at joint 110 by clamping, welding, adhesives, or any method of connection suitable for connecting each half tank 105 at joint 110. In some embodiments, half tanks 105 may be made of molded polypropylene or polyethylene components. In other embodiments, half tanks 105 may alternatively comprise a material other than polypropylene or polyethylene; for instance, other polymers, fiberglass reinforced polyester resin, or concrete.

Half tanks 105 may further comprise access ports 130. Access ports 130 may comprise openings in a top portion of half tank 105 that may allow access to the inside of the wastewater treatment system 100 for maintenance, inspection, and cleaning. In some embodiments, access ports 130 may be covered by cover 135. Cover 135 may prevent wastewater from flowing out of wastewater treatment system 100 and may keep wastewater treatment system 100 fully enclosed. Cover 135 may further provide a protective lid over access ports 130 to prevent access to the interior of wastewater treatment system 100 except for maintenance, inspection, and/or cleaning. Wastewater treatment system 100 may further comprise one or more risers 125. In some embodiments, a riser 125 may be connected to only one access port 130, as depicted in FIG. 1. In other embodiments, a riser 125 may be connected to both access ports 130. Riser 125 may provide at-grade access to wastewater treatment system 100 when wastewater treatment system 100 is buried below grade. Riser 125 may provide access to port 130 for maintenance, inspection, and cleaning of wastewater treatment system 100.

Wastewater treatment system 100 may further comprise an inflow pipe 115 and an outflow pipe 120. Inflow pipe 115 may carry wastewater from a source into wastewater treatment system 100. Outflow pipe 120 may direct a flow of treated wastewater out of wastewater treatment system 100 to a municipal sewer line or a septic tank inlet, not depicted in FIG. 1.

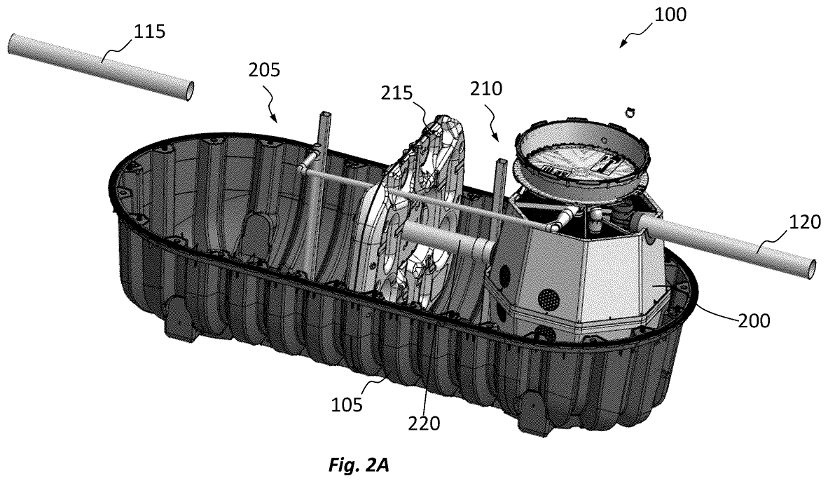

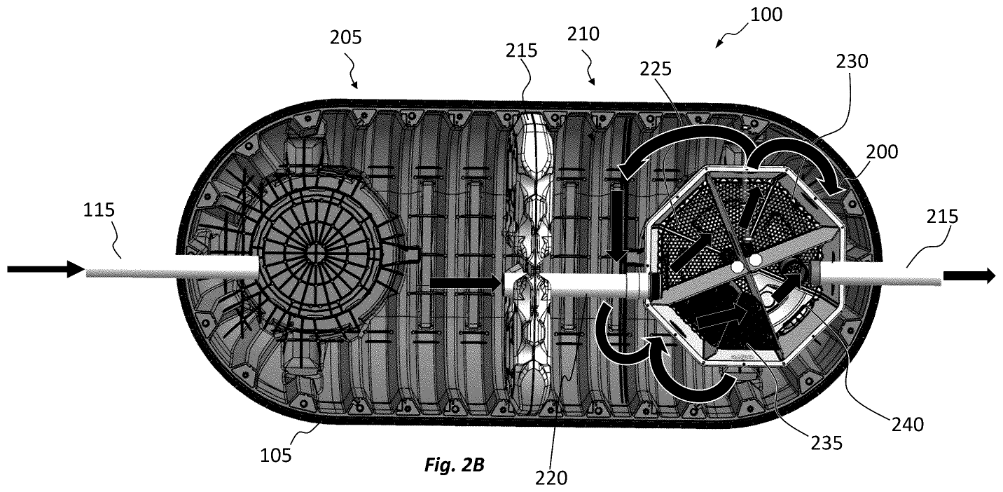

FIG. 2A depicts a perspective view of a wastewater treatment system 100 with the top half tank 105 removed, consistent with embodiments of the present disclosure. As depicted in FIG. 2A, wastewater treatment system 100 may comprise a first chamber 205 and a second chamber 210 separated by a baffle 215. In some embodiments, baffle 215 may be configured to fit within the corrugations of the interior sidewalls of half tank 105. In some embodiments, first chamber 205 and second chamber 210 of wastewater treatment system 100 may have about equal volume. In other embodiments, baffle 125 may be positioned such that first chamber 205 and second chamber 210 have substantially unequal volume. Inflow pipe 115 may carry wastewater from a source into first chamber 205. First chamber 205 may comprise a substantially open compartment within wastewater treatment system 100. Directing the flow of wastewater to first chamber 205 may allow for an initial treatment of the flow of wastewater within first chamber 205. For example, heavier-than-water solids may sink and accumulate as an aggregation at the bottom of first chamber 205. After wastewater has received an initial filtration through first chamber 205, the wastewater may be directed to wastewater treatment unit 200 located in second chamber 210. For example, wastewater may flow through baffle pipe 220 from first chamber 205 to wastewater treatment unit 200 located in second chamber 210 of wastewater treatment system 100. Baffle pipe 220 may extend from first chamber 205 through baffle 215 and into wastewater treatment unit 200. The flow of wastewater may be further treated through wastewater treatment unit 200 in second chamber 210, as disclosed herein. The treated wastewater may then exit wastewater treatment system 100 through outflow pipe 120.

FIG. 2B depicts a flow of wastewater through wastewater treatment system 100, demonstrated by a flow of arrows. As depicted in FIG. 2B, wastewater may enter wastewater treatment system 100 from a source through inflow pipe 115. Inflow pipe 115 may direct the flow of wastewater into first chamber 205. First chamber 205 may provide an initial anaerobic treatment of the flow of wastewater, which may denitrify the wastewater and allow heavier-than-water solids to sink and accumulate as an aggregation at the bottom of first chamber 205. Wastewater may then flow through baffle pipe 220 from first chamber 205 to second chamber 210. Baffle pipe 220 may direct the flow of wastewater through baffle 215 separating first chamber 205 and second chamber 210 and into wastewater treatment unit 200, located in second chamber 210.

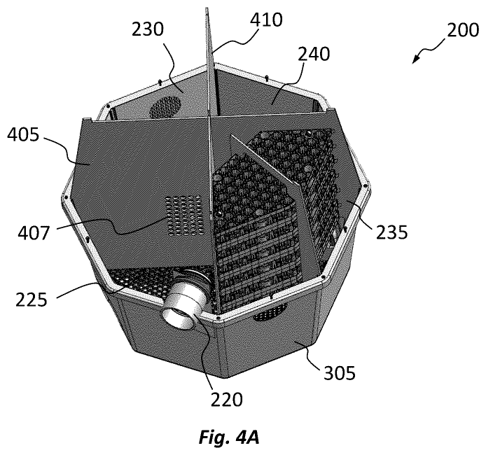

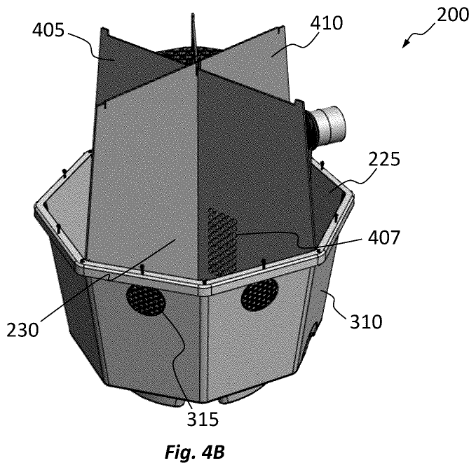

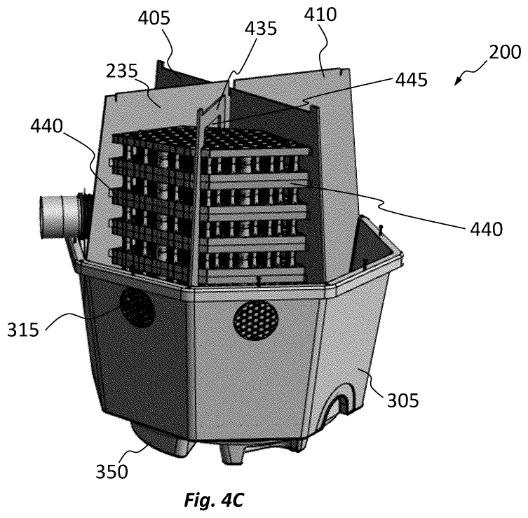

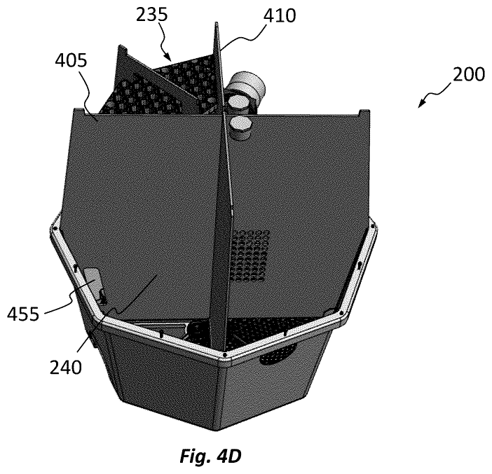

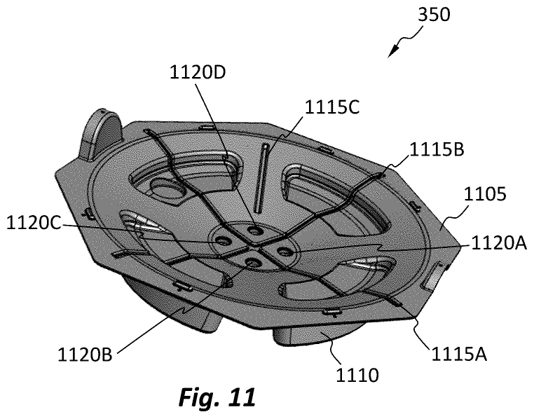

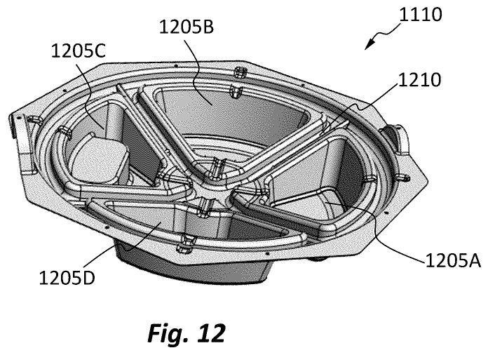

As depicted in FIG. 2B, a top portion of wastewater treatment unit 200 is removed for clarity so that the interior compartments of wastewater treatment unit 200 may be viewed. Wastewater treatment unit 200 may be divided into four compartments: first compartment 225, second compartment 230, third compartment 235, and fourth compartment 240. Wastewater treatment unit 200 may be divided into compartments by dividers, such as dividers 405 and 410, as disclosed herein with respect to FIGS. 4A-4D. The dividers may have holes or openings, as disclosed herein with respect to FIG. 4A-4D, which may allow wastewater to flow in a controlled path through each of the compartments of wastewater treatment unit 200. Wastewater treatment unit 200 may include a mesh surface at the bottom of wastewater treatment unit 200. The mesh surface at the bottom of wastewater treatment unit 200 may break up and allow for even distribution of air bubbles released from an aeration grid integrated below wastewater treatment unit 200, such as aeration grid 350, as disclosed herein with respect to FIG. 11 and FIG. 12. The mesh surface may further support wastewater filtration media within wastewater treatment unit 200.

Baffle pipe 220 may direct the flow of wastewater into first compartment 225 of wastewater treatment unit 200 which may aerate the flow of wastewater. Aeration of the wastewater in first compartment 225 may facilitate aerobic biodegradation of organic materials in the flow of wastewater. Wastewater may then flow through an opening in the dividers from first compartment 225 to second compartment 230. Second compartment 230 may provide additional aeration of the flow of wastewater, which may convert ammonia to nitrate to provide filtration of the wastewater. Wastewater may then exit second compartment 230 of wastewater treatment unit 200 through an opening in the outer wall of wastewater treatment unit 200, such as uncovered mesh opening 315 as depicted in FIG. 4B, and may enter second chamber 210 of wastewater treatment system 100. Wastewater may be anaerobically treated in second chamber 210. The larger anaerobic volume of second chamber 210 may convert nitrate in the wastewater into nitrogen gas. In some embodiments, the volume of second chamber 210 may be larger than the volume of wastewater treatment unit 200. Wastewater may then flow from second chamber 210 into third compartment 235 of wastewater treatment unit 200 through an opening in the outer wall of wastewater treatment unit 200, such as uncovered mesh opening 315, as depicted in FIG. 4C. Third compartment 235 may contain a fixed bed biological reactor (“FBBR”) system. Wastewater may flow through the FBBR system in third compartment 235 to allow remaining solids to settle out of the wastewater. The wastewater may then flow from third compartment 235 through an opening in the dividers to fourth compartment 240 of wastewater treatment unit 200. Fourth compartment 240 may allow for further clarification of the flow of wastewater, which may allow any remaining suspended solids to settle from the flow of wastewater. The filtered wastewater may then be directed out of fourth compartment 240 and out of wastewater treatment system 100 through outflow pipe 120.

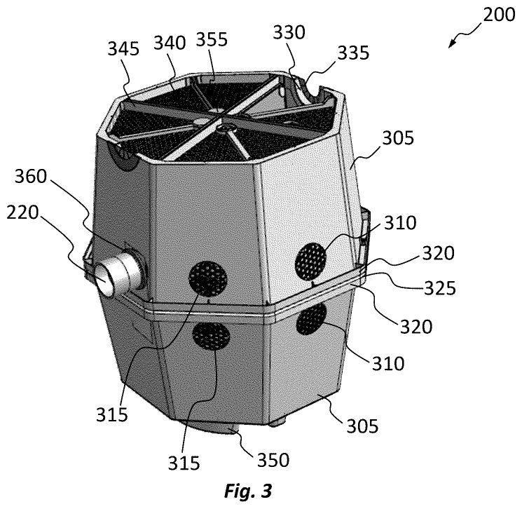

FIG. 3 depicts wastewater treatment unit 200 for use within a wastewater treatment system, such as wastewater treatment system 100, consistent with embodiments of the present disclosure. Wastewater treatment unit 200 may comprise two identical half treatment units 305 and an aeration grid 350. In some embodiments, as depicted in FIG. 3, each half treatment unit 305 may be generally octagonal in shape. In other embodiments, each half treatment unit 305 may be square, rectangular, circular, elliptical, or any other shape. In some embodiments, half treatment unit 305 may be made of molded polypropylene or polyethylene components. In other embodiments, half treatment unit 305 may alternatively comprise a material other than polypropylene or polyethylene; for instance, other polymers, fiberglass reinforced polyester resin, or concrete. Half treatment units 305 may be nested to provide efficiency during storage and transportation. Each half treatment unit 305 may include a lip 320. Lip 320 may extend radially outwardly from an outer surface of half treatment unit 305. Two half treatment units 305 may be mated at joint 325 by clamping, welding, adhesives, or any method of connection suitable for connecting each half treatment unit 305 at joint 325. Mating two half treatment units 305 may create an interior volume of wastewater treatment unit 200 for the treatment and filtration of a flow of wastewater. In other embodiments, wastewater treatment unit 200 may be made from a hollow structure formed from one piece rather than two half treatment units mated at a joint. In other embodiments, wastewater treatment unit 200 may be formed using more than two pieces. Wastewater treatment unit 200 may further include an integrated aeration grid 350, as disclosed herein with respect to FIGS. 11 and 12.

Half treatment unit 305 may further comprise opening 360 in a sidewall of half treatment unit 305. The size and shape of opening 360 may correspond to the size and shape of baffle pipe 220 to allow baffle pipe 220 to direct a flow of wastewater into wastewater treatment unit 200, as disclosed herein. Opening 360 may further comprise a gasket (not shown in FIG. 3). The gasket may be made of rubber or elastomer material and may impede the flow of water out of wastewater treatment unit 200 through opening 360, making opening 360 watertight at this location. In other embodiments, where resistance to water passage at opening 360 is not needed, wastewater treatment unit 200 may be assembled without the use of a gasket at opening 360.

Half treatment unit 305 may further comprise uncovered mesh opening 315 and covered mesh opening 310. Uncovered mesh opening 315 may comprise an opening in a side of half treatment unit 305 that may allow wastewater to flow into or out of wastewater treatment unit 200, as disclosed herein with respect to FIGS. 4A-4D. Covered mesh opening 310 may prevent wastewater from flowing through the walls of wastewater treatment unit 200. The use of covered mesh openings 310 and uncovered mesh openings 315 may allow for manufacturing efficiencies in the production of wastewater treatment units 200, while also ensuring that the flow of wastewater is entering and exiting the wastewater treatment unit 200 at the appropriate locations.

Each half treatment unit 305 may further include mesh surface 340. Mesh surface 340 may comprise a plurality of openings connected in a grid-like pattern to allow for a flow of material through mesh surface 340. In some embodiments, the plurality of openings may be hexagonal in shape. In other embodiments, the plurality of openings may be circular, rectangular, square, octagonal, elliptical, or any other shape. Mesh surface 340 may serve as the top of the upper half treatment unit 305 and may serve as the bottom of the lower half treatment unit 305. When mesh surface 340 serves as the bottom of the lower half treatment unit 305, mesh surface 340 may break up and allow for even distribution of air bubbles released from aeration grid 350, as disclosed herein. Mesh surface 340 may further support wastewater filtration media within wastewater treatment unit 200.

Each half treatment unit 305 may further include supports 345. Supports 345 may hold and secure dividers (not shown in FIG. 3) within wastewater treatment unit 200. For example, dividers may be placed within supports 345 such that supports 345 may hold the dividers in place during operation of wastewater treatment unit 200. Each half treatment unit 305 may further comprise pipe supports 355. Pipe supports may secure air lift piping and aeration grid piping (not shown in FIG. 3) that may be installed within wastewater treatment unit 200. The pipe supports may provide a location for the air lift pipes and aeration grid pipe to enter wastewater treatment system 200 and may further support the air lift pipes and aeration grid pipe during operation of wastewater treatment unit 200.

Each half treatment unit 200 may further include saddle 330 and gasket 335. Saddle 330 may support an inflow pipe or an outflow pipe (not shown in FIG. 3). For example, saddle 330 may comprise a substantially U-shaped cutout in half treatment unit 200 that may be used to support an inflow or an outflow pipe during operation of wastewater treatment unit 200. Further a gasket, such as gasket 335 may be included at saddle 330 to provide a watertight connection between saddle 330 and an inflow or an outflow pipe. Gasket 335 may be made of rubber or elastomer material and may impede the flow of water in or out of wastewater treatment unit 200 through the connection between saddle 330 and an inflow or outflow pipe, making wastewater treatment unit 200 watertight at this location. In other embodiments, where resistance to water passage between saddle 330 and an inflow or an outflow pipe is not needed, wastewater treatment unit 200 may be assembled without the use of gasket 335 at saddle 330.

FIGS. 4A-4D illustrate an interior of wastewater treatment unit 200 through which wastewater may flow for treatment. FIG. 4A depicts an interior of the wastewater treatment unit 200. Wastewater treatment unit 200 may be divided into first compartment 225, second compartment 230, third compartment 235, and fourth compartment 240 by first divider 405 and second divider 410. First divider 405 and second divider 410 may comprise an insert within wastewater treatment unit 200 and may direct the flow of wastewater through the compartments 225, 230, 235, 240 of wastewater treatment unit 200.

Baffle pipe 220 may direct the flow of wastewater from the first chamber of wastewater treatment system 100 into first compartment 225 of wastewater treatment unit 200. First compartment 225 may be a substantially open compartment that may permit aerobic treatment of the flow of wastewater to remove organic matter in the flow of wastewater through microbial decomposition. An aeration grid, such as aeration grid 350 as disclosed herein with respect to FIGS. 11 and 12, may aerate the flow of wastewater in first compartment 225 to aerobically treat the flow of wastewater. First compartment 225 may also use biofilm and/or microorganisms such as bacteria, algae, or fungi in the treatment of the flow of wastewater. In some embodiments, first compartment 225 may include a moving bed biofilm reactor (“MBBR”). The MBBR may include plastic carriers on which microorganisms may grow, which may increase the number of microorganisms present to treat the wastewater in first compartment 225 and may prevent the microorganisms from escaping first compartment 225. For example, biofilm and bacteria may attach to the MBBR plastic carriers and the plastic carriers may facilitate growth and increase of residence time of the biofilm within first compartment 225. The increased growth of the biofilm within first compartment 225 may provide improved treatment of wastewater flowing through first compartment 225. In other embodiments, first compartment 225 may include biofilm which may not be attached to plastic carriers of an MBBR system. Such biofilm may also grow through a suspended growth process in which the biofilm is suspended in the wastewater by mixing and/or aeration. In other embodiments, first compartment 225 may include biofilm that may grow through an attachment to a fixed bed biological reactor (“FBBR”) system, as disclosed herein. The biofilm in combination with aeration from an aeration grid, such as aeration grid 350 (as depicted in FIGS. 11 and 12), in first compartment 225 may convert ammonia in the flow of wastewater into nitrate.

Wastewater in first compartment 225 may flow to second compartment 230 through a plurality of openings 407 in first divider 405. As depicted in FIG. 4A, openings 407 may comprise a grid of circular openings in first divider 405. However, in other embodiments, there may be more or fewer openings 407. Openings 407 may be square, rectangular, elliptical, circular, triangular, or any other shape suitable for allowing a flow of wastewater through first divider 405.

FIG. 4B depicts second compartment 230 formed within wastewater treatment unit 200 by first divider 405 and second divider 410. Second compartment 230 may comprise a substantially open compartment that may permit aerobic treatment of the flow of wastewater to remove additional organic matter in the flow of wastewater received from first compartment 225. An aeration grid, such as aeration grid 350 as disclosed herein with respect to FIGS. 11 and 12, may aerate the flow of wastewater in second compartment 230 to aerobically treat the flow of wastewater. In some embodiments, second compartment 230 may also include an MBBR system or may include biofilm that is not attached to plastic carriers of an MBBR system. The biofilm may be provided in a higher proportion in second compartment 230 than first compartment 225. Accordingly, the combination of the biofilm and aeration within second compartment 230 may further convert ammonia within the flow of wastewater to nitrate.

Wastewater may then flow out of second compartment 230 of wastewater treatment unit 200 through uncovered mesh opening 315 into the second chamber of the larger wastewater treatment system, such as second chamber 210 of wastewater treatment system 100 (not shown in FIG. 4B). Second chamber 210 of wastewater treatment system 100, as depicted in FIG. 2B, may provide a large anaerobic space to convert nitrate in the flow of wastewater into nitrogen gas. While the wastewater circulates through the second chamber of the wastewater treatment system, solids in the flow of wastewater may also settle out of the wastewater in an aggregation at the bottom of the second chamber.

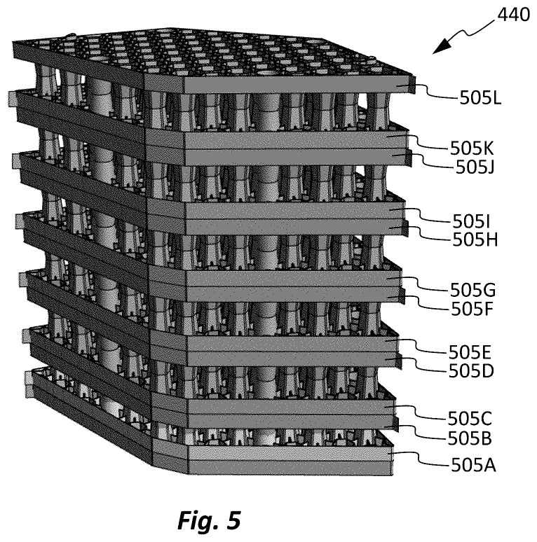

FIG. 4C depicts third compartment 235 of wastewater treatment unit 200. After being anaerobically treated in second chamber 210 of wastewater treatment system 100, wastewater may enter third compartment 235 from second chamber 210 of wastewater treatment system 100 through uncovered mesh opening 315. Third compartment 235 may provide a polish treatment of the wastewater to remove remaining contaminants in the flow of wastewater. Third compartment 235 may include at least one fixed bed biological reactor (FBBR) system 440. The FBBR system 440 may comprise a plurality of media blocks, as disclosed herein with respect to FIGS. 5-7, with biofilm attached. The biofilm may provide a high rate of pollutant removal within a small area of the wastewater treatment unit 200. FBBR system 440 may provide a polishing of the flow of wastewater to remove remaining suspended solids and BOD from the flow of wastewater, as disclosed herein with respect to FIGS. 5-7.

In some embodiments, as depicted in FIG. 4C, third compartment 235 may include two FBBR systems 440 separated by a baffle 435. Baffle 435 may prevent the flow of wastewater from entering the second FBBR system 440 before it passes through the first FBBR system 440 to ensure that the wastewater is fully treated through both the first and the second FBBR systems 440. The wastewater may enter third compartment 235 from second chamber 210 of wastewater treatment system 100 through uncovered mesh opening 315. Uncovered mesh opening 315 may be located at the lower portion of the first FBBR system 440. Accordingly, the flow of wastewater may be forced upwards through the first FBBR system 440 for polishing and removal of suspended solids and pollutants. The flow of wastewater may be forced upwardly through the use of forced air released from aeration grid 350. For example, aeration grid 350 may release oxygen within third compartment 235 below the first FBBR system 440 to force the flow of wastewater upwards through the first FBBR system 440. After flowing upwardly through the first FBBR system, the flow of wastewater may then flow through opening 445 in baffle 435. Wastewater may then flow downwardly through the second FBBR system 440 for additional polishing and removal of remaining suspended solids. Aeration grid 350 may not release oxygen into third compartment 235 below the second FBBR system 440. The lack of forced air flowing upwardly from aeration grid 350 may allow the flow of wastewater to be drawn downwardly through the second FBBR system 440 by gravity. The wastewater may receive a final polishing treatment through the second FBBR system 440 as it flows downwardly in third compartment 235. Although FIG. 4C depicts FBBR system 440, any suitable FBBR system may be used within third compartment 235 to filter solids from the flow of wastewater.

FIG. 4D depicts fourth compartment 240 formed by first divider 405 and second divider 410. Wastewater may flow from third compartment 235 to fourth compartment 240 through opening 455 in first divider 405. Fourth compartment 240 may retain the substantially treated wastewater and allow for the removal of the wastewater from the wastewater treatment unit 200. In some embodiments, an aeration grid, such as aeration grid 350 as disclosed herein with respect to FIG. 11 and FIG. 12, may release oxygen into fourth compartment 240 for further clarification of the flow of wastewater. An outflow pipe, such as outflow pipe 120 (not shown in FIG. 4D), may be installed within fourth compartment 240. The flow of treated wastewater within fourth compartment 240 may exit the wastewater treatment unit 200 through the outflow pipe.

FIG. 5 depicts an FBBR system 440 for use in a wastewater treatment unit, such as wastewater treatment unit 200. FBBR system 440 may comprise a plurality of media blocks 505A-505L. As depicted in FIG. 5, FBBR system 440 may comprise 12 media blocks 505A-505L. However, in other embodiments, FBBR system 440 may comprise more or fewer media blocks. Media blocks 505A-505L may be interconnected to create an FBBR system 440 that may be installed within a wastewater treatment unit, such as wastewater treatment unit 200. The interconnected media blocks 505A-505L may provide a surface area for purifying biomass to grow. The media blocks 505A-505L may be spaced apart such that the purifying biomass may not grow too closely together, which could impede the flow of wastewater through the FBBR system 440. The media blocks 505A-505L may allow for high concentrations of the purifying biomass within the compact footprint of the FBBR system 440 and may ensure high rates of biological oxidation within the flow of wastewater through media blocks 505A-505L. Wastewater may flow through media blocks 505A-505L and the biomass supported by media blocks 505A-505L may polish the wastewater to remove final amounts of pollutants from the wastewater. Media blocks 505A-505L may be stacked in a nested configuration to create space efficiencies during storage and transportation of media blocks 505A-505L. Media blocks 505A-505L may then be assembled into the FBBR system 440 as depicted in FIG. 5 prior to installation in a wastewater treatment unit.

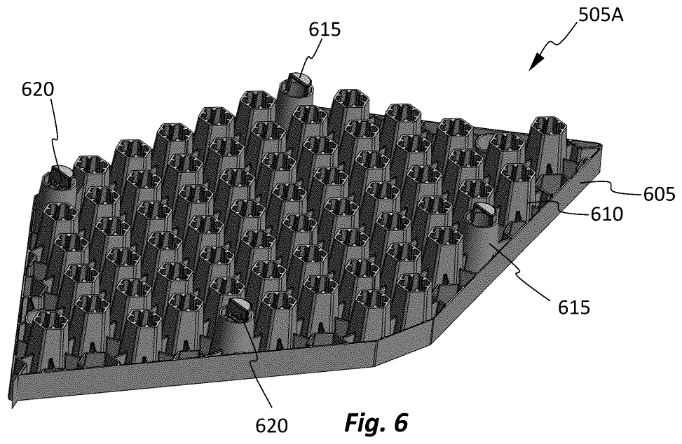

FIG. 6 depicts a perspective view of a side of a media block 505A with media extensions 610 extending from a base 605 for use in an FBBR system, such as FBBR system 440, in accordance with disclosed embodiments. Media block 505A may comprise a base 605 which may connect a plurality of media extensions 610. Media extensions 610 may extend upwardly from base 605 and may provide an increased surface area for the attachment and growth of biomass on media block 505A. In some embodiments, as depicted in FIG. 6, media extensions 610 may be generally hexagonal in shape. In other embodiments, media extensions 610 may be square, rectangular, circular, elliptical, octagonal, or any other shape. Media extensions 610 may be spaced apart such that biomass attached to and growing on media extensions 610 may not grow together, which could impede the flow of wastewater through media block 505A. Media block 505A may further comprise open connectors 615 and snap connectors 620. Open connectors 615 and snap connectors 620 may be used to connect one media block, such as media block 505A, with another media block to form a FBBR system. Media block 505A may be oriented such that the side of media block 505A with media extensions 610 extending from base 605 is facing upwardly. A second media block may be oriented such that the side of the second media block with media extensions extending from the base is facing downwardly and may be facing towards the upward facing side of media block 505A. Open connectors 615 of media block 505A may interconnect with snap connectors of the second media block that may be facing towards the upward facing side of media block 505A and snap connectors 620 of media block 505A may interconnect with open connectors of the second media block that may be facing towards the upward facing side of media block 505A to assemble an FBBR system. In some embodiments, as depicted in FIG. 6, media block 505A may comprise two open connectors 615 and two snap connectors 620. In other embodiments, media block 505A may comprise more or fewer open connectors 615 and snap connectors 620.

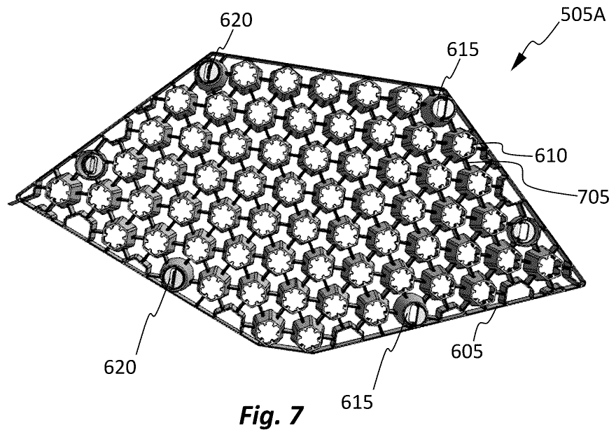

FIG. 7 depicts a top view of one media block 505A, in accordance with disclosed embodiments. As depicted in FIG. 7, media extensions 610 may be interconnected in a grid-like configuration. Each media extension 610, open connector 615, and snap connector 620 may be interconnected by a plurality of connections 705. Connections 705 may extend from the face of media extensions 610, open connectors 615, and snap connectors 620 to interconnect media extensions 610, open connectors 615, and snap connectors 620 in a grid-like configuration. The configuration of media extensions 610, open connectors 615, and snap connectors 620 with connections 705 may allow for wastewater to flow through base 605 for polishing and removal of pollutants when media block 505A is installed within a wastewater treatment unit.

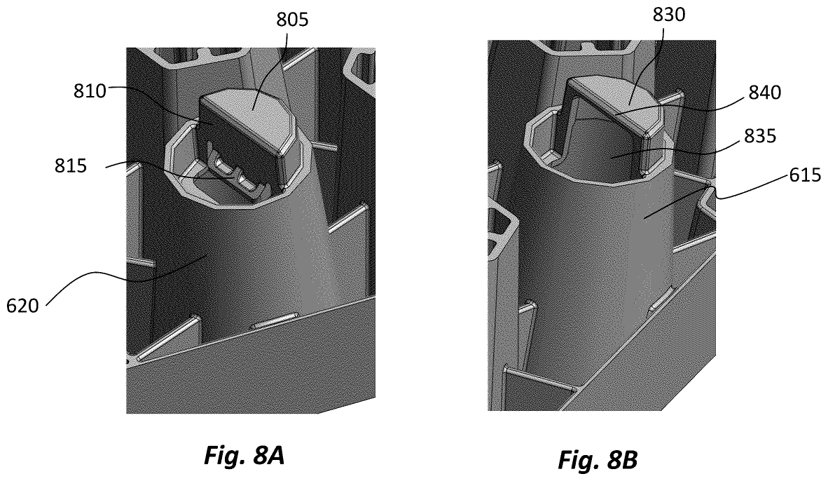

FIG. 8A depicts an enlarged view of a snap connector 620 and FIG. 8B depicts an enlarged view of open connector 615. A snap connector 620 of one media block may be interconnected with an open connector 615 of a second media block when assembling an FBBR system from a plurality of media blocks. As depicted in FIG. 8A, snap connector 620 may comprise a top surface 805 and a vertical surface 810. Top surface 805 and vertical surface 810 may engage with open connector 615 to provide a frictional connection between snap connector 620 and open connector 615. Snap connector 620 may further comprise a canted surface 815. Canted surface 815 may extend outwardly at an angle from a lower portion of vertical surface 810. Canted surface 815 may engage with open connector 615 to lock open connector 615 into snap connector 620. As depicted in FIG. 8B, open connector 615 may comprise a top surface 830. Top surface 830 may engage with snap connector 620 to provide a frictional connection between snap connector 620 and open connector 615. Top surface 830 may comprise a lip 840. Lip 840 may extend laterally downwardly from top surface 830. Lip 840 may engage with canted surface 815 of snap connector 620 to lock open connector 615 into snap connector 620. Open connector 615 may further comprise an opening 835. Opening 835 may provide an open area of open connector 615 such that open connector 615 may be installed within snap connector 620.

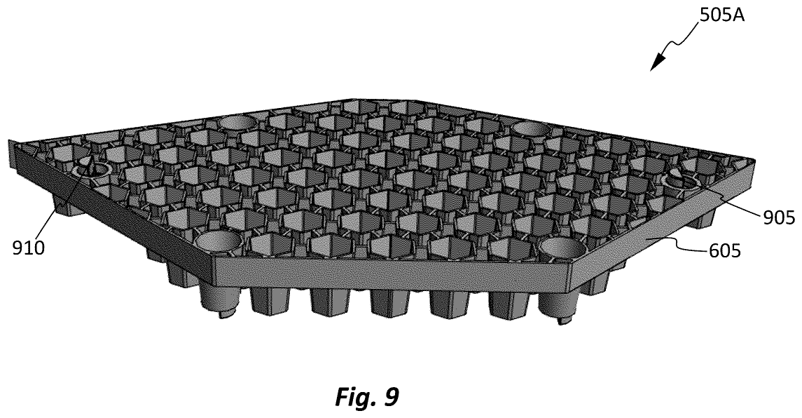

FIG. 9 depicts a perspective view of a flat side of a media block 505A. The flat side of media block 505A may comprise a substantially flat surface in line with base 605. The flat side of media block 505A may include an open connector 905 and a snap connector 910. The flat side of media block 505A may be aligned with the flat side of a second media block. The open connector 905 on the flat side of media block 505A may interconnect with a snap connector on the flat side of the second media block and snap connector 910 on the flat side of media block 505A may interconnect with an open connector on the flat side of the second media block to assemble an FBBR system. In some embodiments, as depicted in FIG. 9, media block 505A may comprise one open connector 905 and one snap connector 910. In other embodiments, media block 505A may comprise more or fewer open connectors 905 and snap connectors 910.

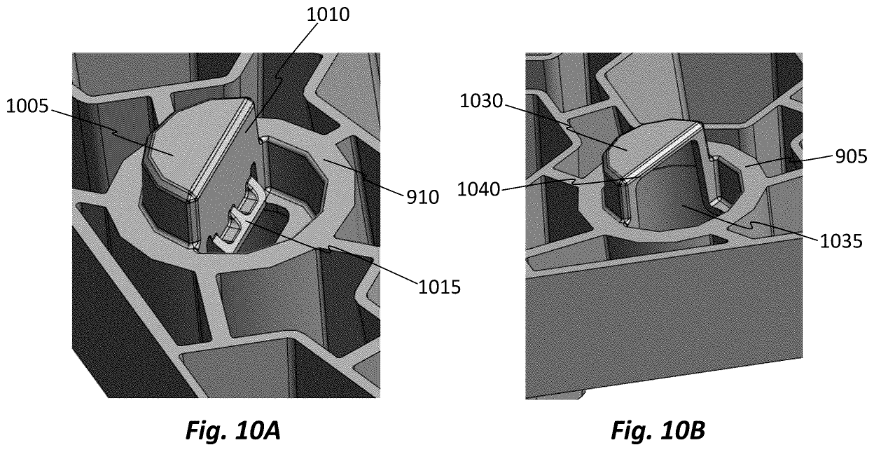

FIG. 10A depicts an enlarged view of a snap connector 910 and FIG. 10B depicts an enlarged view of open connector 905. A snap connector 910 of one media block may be interconnected with an open connector 905 of a second media block when assembling an FBBR system from a plurality of media blocks. As depicted in FIG. 10A, snap connector 910 may comprise a top surface 1005 and a vertical surface 1010. Top surface 1005 and vertical surface 1010 may engage with open connector 905 to provide a frictional connection between snap connector 910 and open connector 905. Snap connector 910 may further comprise a canted surface 1015. Canted surface 1015 may extend outwardly at an angle from a lower portion of vertical surface 1010. Canted surface 1015 may engage with open connector 905 to lock open connector 905 into snap connector 910. As depicted in FIG. 10B, open connector 905 may comprise a top surface 1030. Top surface 1030 may engage with snap connector 910 to provide a frictional connection between snap connector 910 and open connector 905. Top surface 1030 may comprise a lip 1040. Lip 1040 may extend laterally downwardly from top surface 1030. Lip 1040 may engage with canted surface 1015 of snap connector 910 to lock open connector 905 into snap connector 910. Open connector 905 may further comprise an opening 1035. Opening 1035 may provide an open area of open connector 905 such that open connector 905 may be installed within snap connector 910.

FIG. 11 depicts aeration grid 350 for use in a wastewater treatment unit, such as wastewater treatment unit 200. Aeration grid 350 may provide oxygen to wastewater treatment unit 200 to facilitate aerobic biodegradation of organic materials and pollutants in the wastewater. In addition to providing oxygen for aerobic treatment of wastewater, aeration grid 350 may also prevent buoyancy of wastewater treatment unit 200 by providing mass at the bottom of wastewater treatment unit 200. In an embodiment, aeration grid 350 may be made from a thermoplastic polymer such as acrylonitrile butadiene styrene (ABS), polyvinyl chloride (PVC), or any suitable polymers for forming aeration grid 350.

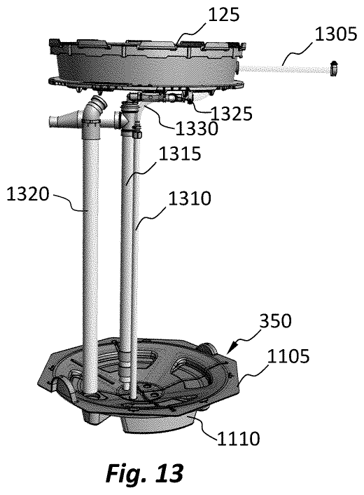

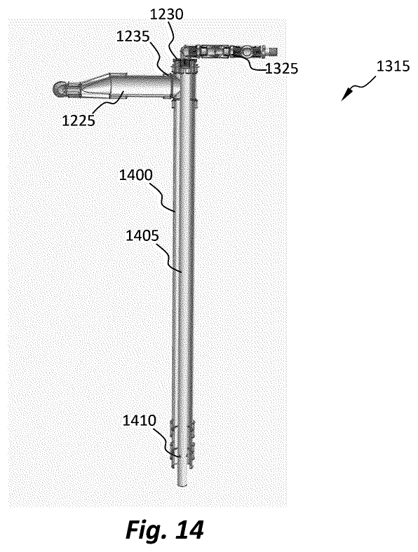

Aeration grid 350 may be positioned below a wastewater treatment unit, such as wastewater treatment unit 200. Aeration grid 350 may comprise a cover 1105 and a base 1110. Cover 1105 may be installed over base 1110. Oxygen may be released from aeration grid 350 to promote aerobic biodegradation of organic materials in the wastewater being treated within wastewater treatment unit 200. Although not depicted in FIG. 11, cover 1105 may include a plurality of holes to allow for oxygen to be released from within base 1110 through cover 1105 to enter wastewater treatment unit 200 at specific locations. Cover 1105 may comprise slots 1115A-1115C. Slots 1115A-1115C may comprise indentations in cover 1105 and may correspond to dividers, such as dividers 405 and 410, and a baffle, such as baffle 435. Slots 1115A-1115C may secure dividers 405, 410 and baffle 435 in place within the wastewater treatment unit, such as wastewater treatment unit 200. Cover 1105 may further comprise circular indentations 1120A-1120D. Circular indentations 1120A-1120D may comprise a depression in the surface of cover 1105. Circular indentations 1120A-1120D may support pipes related to the air lift system (not depicted in FIG. 11), disclosed herein with respect to FIGS. 13-14. In some embodiments, as disclosed herein with respect to FIG. 13, at least one of circular indentations 1120A-1120D may comprise an opening in cover 1105 through which an aeration pipe may be installed.

FIG. 12 depicts base 1110 of aeration grid 350. Base 1110 of aeration grid 350 may include compartments 1205A-1205D. Compartments 1205A-1205D may be filled with sand, concrete, or any other filler material. Filling compartments 1205A-1205D with sand or concrete may provide anti-buoyancy control to wastewater treatment unit 200 and may prevent wastewater treatment unit 200 from moving or shifting during use. Base 1110 may further comprise channels 1210. Channels 1210 may comprise indentations between compartments 1205A-1205D. An aeration pipe may extend through cover 1105 (not depicted in FIG. 12) to base 1110 and may deliver oxygen to channels 1210. Oxygen may disperse through channels 1210 and release into wastewater treatment unit 200 at specific locations through holes in cover 1105. Channels 1210 may distribute oxygen throughout aeration grid 350 such that oxygen may be released at specific locations within wastewater treatment unit 200 (for example, in first compartment 225 and second compartment 230, which provide aerobic treatment of the flow of wastewater).

FIG. 13 depicts aeration pipes and an aeration grid of a wastewater treatment unit, such as wastewater treatment unit 200, with all other components of the wastewater treatment unit removed for clarity. Supply pipe 1305 may be connected to an above-ground air compressor (not depicted in FIG. 13). The above-ground air compressor may provide oxygen for use by aeration grid pipe 1310 and air lift system 1315 within the wastewater treatment unit 200. In some embodiments supply pipe 1305 may comprise a flexible tube which may allow supply pipe 1305 to be bent for installation within the wastewater treatment unit. In some embodiments, as depicted in FIG. 13, supply pipe 1305 may extend through riser 125 to enter the wastewater treatment unit 200.

Supply pipe 1305 may extend from the air compressor to a tee fitting 1325. Tee fitting 1325 may direct the flow of oxygen from supply pipe 1305 to both aeration grid pipe 1310 and air lift system 1315. Aeration grid pipe 1310 may be connected to tee fitting 1325 by connection pipe 1330. Connection pipe 1330 may comprise a flexible tube which may allow connection pipe 1330 to connect aeration grid pipe 1310 with tee fitting 1325. Aeration grid pipe 1310 may extend downwardly from connection pipe 1330 to aeration grid 350. Aeration grid pipe 1310 may extend through an opening in cover 1105 into base 1110. As disclosed herein with respect to FIG. 12, aeration grid pipe 1310 may deliver oxygen to channels within base 1110 of aeration grid 350. Oxygen then may be released through openings in cover 1105 of aeration grid 350 into the wastewater being treated within wastewater treatment unit 200. Tee fitting 1325 may also direct the flow of oxygen from the air compressor to air lift system 1315, as disclosed herein with respect to FIG. 14.

Wastewater treatment unit 200 may further include access pipe 1320. Access pipe 1320 may extend through aeration grid 350 and may facilitate removal of solids that may accumulate under base 1110. For example, when wastewater treatment unit 200 is in use, solids may settle out of the flow of wastewater and may become lodged under base 1110 of aeration grid 350. Access pipe 1320 may allow solids that accumulate under base 1110 of aeration grid 350 to be pumped out of the system.

FIG. 14 depicts a section cut of an air lift system 1315 for use within a wastewater treatment unit, such as wastewater treatment unit 200. The air lift system 1315 may comprise an interior air lift pipe 1405 and an exterior air lift pipe 1400. The interior air lift pipe 1405 may be located within the exterior air lift pipe 1400. Tee fitting 1325 may connect interior air lift pipe 1405 to a source of oxygen, such as an above-grade air compressor. The oxygen may flow downwardly through interior air lift pipe 1405, which may be located within exterior air lift pipe 1400. A bottom of interior airlift pipe 1405 may extend further downwardly than a bottom of exterior air lift pipe 1400. The bottom of interior air lift pipe 1405 may engage with one of circular indentations 1120A-1120D of cover 1105 of aeration grid 350, as disclosed herein with respect to FIG. 11. Interior air lift pipe 1405 may be secured in place within the wastewater treatment unit 200 through connection with one of circular indentations 1120A-1120D. Interior air lift pipe 1405 may further comprise a plurality of openings 1410 at a lower portion of interior air lift pipe 1405. In some embodiments, interior air lift pipe 1405 may comprise three openings 1410. In other embodiments, interior air lift pipe 1405 may include more or fewer openings 1410. Openings 1410 may be located at a portion of interior air lift pipe 1405 that is located within exterior air lift pipe 1400.

Oxygen supplied from an air compressor may flow downwardly through interior air lift pipe 1405. The oxygen may be released from within interior air lift pipe 1405 through openings 1410. The oxygen exiting openings 1410 may create air bubbles. The air bubbles may flow upwardly from openings 1410 through the space between interior air lift pipe 1405 and exterior air lift pipe 1400. The air bubbles may mix with the wastewater located within the wastewater treatment unit 200 and may draw the wastewater up through the exterior air lift pipe 1400 with the air bubbles. Exterior air lift pipe 1400 may include a cap 1420 at the upper opening of exterior air lift pipe 1400 to prevent the flow of water from exiting through the upper opening of exterior air lift pipe 1400. The flow of the air bubble and wastewater mixture may be directed through a tee pipe fitting 1425 to discharge pipe 1415.

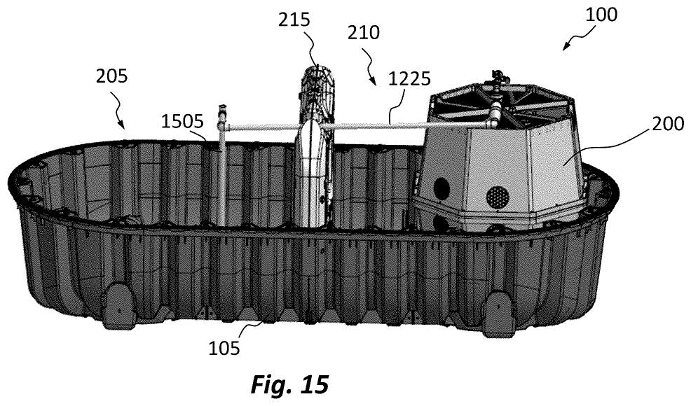

FIG. 15 depicts the air lift system piping within the wastewater treatment system 100. As depicted in FIG. 15, discharge pipe 1415 may carry the air bubble and wastewater mixture from wastewater treatment unit 200 in the second chamber 210 of wastewater treatment system 100 through baffle 215 into first chamber 205 of wastewater treatment system 100. Discharge pipe 1415 may connect with vertical discharge pipe 1505, which may be located in first chamber 205 of wastewater treatment system 100. The flow of the air bubble and wastewater mixture from wastewater treatment unit 200 may discharge downwardly through vertical discharge pipe 1505 into first chamber 205. The wastewater that is drawn through the air lift system 1315 and discharged into first chamber 205 may be used to reduce BOD levels in the wastewater in first chamber 205 before the wastewater enters the wastewater treatment unit 200. Further, moving the nitrified wastewater from wastewater treatment unit 200 into first chamber 205 may introduce the nitrified wastewater into the carbon-rich anaerobic first chamber 205. This may allow for denitrification of the wastewater within first chamber 205.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and, accordingly, all suitable modifications and equivalents may be resorted to, falling within the scope of the disclosure.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A water treatment unit for use in a water treatment system, the water treatment unit comprising:
a hollow unit forming an interior volume;
a first divider and a second divider, wherein the first divider and the second divider are configured to divide the interior volume into a first compartment, a second compartment, a third compartment, and a fourth compartment;
the first compartment comprising a first open compartment containing a first biofilm;
the second compartment comprising a second open compartment containing a second biofilm;
the third compartment comprising a fixed bed biological reactor (FBBR) system; and
the fourth compartment comprising a third open compartment to retain a flow of treated water.

2. The water treatment unit of claim 1, wherein the hollow unit comprises a first half unit and a second half unit mated at a joint.

3. The water treatment unit of claim 2, wherein the first half unit and the second half unit are identical.

4. The water treatment unit of claim 2, wherein the first half unit comprises a mesh top surface and the second half unit comprises a mesh bottom surface.

5. The water treatment unit of claim 2, wherein the first half unit further comprises:
a saddle, wherein the saddle supports an outflow pipe; and
a gasket on the saddle, wherein the gasket provides a watertight connection between the saddle and the outflow pipe.

6. The water treatment unit of claim 2, wherein the first half unit and the second half unit further comprise a plurality of divider supports, wherein the plurality of divider supports secure the first divider and the second divider within the interior volume.

7. The water treatment unit of claim 2, wherein the first half unit and the second half unit further comprise:
a first mesh opening associated with the second compartment, wherein the first mesh opening allows an outflow of water from the second compartment; and
a second mesh opening associated with the third compartment, wherein the second mesh opening allows an inflow of water into the third compartment.

8. The water treatment unit of claim 1, wherein the first divider comprises:
a plurality of openings between the first compartment and the second compartment; and
an opening between the third compartment and the fourth compartment.

9. The water treatment unit of claim 1, wherein the fourth compartment further comprises an outflow pipe, the outflow pipe being configured to remove treated water from the water treatment unit.

10. The water treatment unit of claim 1, wherein the FBBR system comprises a first plurality of media blocks and a second plurality of media blocks separated by a baffle.

11. The water treatment unit of claim 10, wherein the baffle comprises:
a solid divider between the first plurality of media blocks and the second plurality of media blocks; and
an opening at a top portion of the baffle.

12. The water treatment unit of claim 10, wherein a media block from the first plurality of media blocks comprises:
a base;
a plurality of media extensions extending upwardly from the base;
a plurality of connections connecting the plurality of media extensions;
at least one snap connector extending upwardly from the base;
at least one open connector extending upwardly from the base;
at least one snap connector extending downwardly from the base; and
at least one open connector extending downwardly from the base.

13. The water treatment unit of claim 11, wherein a flow of water flows upwardly through the first plurality of media blocks, through the opening at the top portion of the baffle, and downwardly through the second plurality of media blocks.

14. A water treatment unit for use in a water treatment system, the water treatment unit comprising:
a hollow unit forming an interior volume;
a first divider and a second divider, wherein the first divider and the second divider are configured to divide the interior volume into a first compartment, a second compartment, a third compartment, and a fourth compartment;
an aeration grid, wherein the aeration grid releases oxygen into the interior volume; and
an aeration grid pipe, wherein the aeration grid pipe supplies oxygen to the aeration grid.

15. The water treatment unit of claim 14, wherein the aeration grid comprises:
a cover, wherein the cover comprises:
a plurality of holes to release oxygen into the water treatment unit;
a plurality of slots, wherein the plurality of slots secures the first divider and the second divider; and
a plurality of indentations, wherein the plurality of indentations secures the aeration grid pipe and an air lift system;
a base, wherein the base comprises:
a plurality of channels spaced between a plurality of compartments, wherein the plurality of channels distribute oxygen throughout the base.

16. The water treatment unit of claim 15, wherein the base further comprises a filler material within one or more of the plurality of compartments.

17. A water treatment unit for use in a water treatment system, the water treatment unit comprising:
a hollow unit forming an interior volume;
a first divider and a second divider, wherein the first divider and the second divider are configured to divide the interior volume into a first compartment, a second compartment, a third compartment, and a fourth compartment;
an aeration grid, wherein the aeration grid releases oxygen into the interior volume; and
an air lift system, wherein the air lift system recirculates water within the water treatment system.

18. The water treatment unit of claim 17, wherein the water treatment unit further comprises:
an air compressor;
a supply pipe connected to the air compressor; and
a tee fitting connected to the supply pipe, wherein the tee fitting further connects to the air lift system and an aeration grid pipe.

19. The water treatment unit of claim 18, wherein the air lift system comprises:
an interior pipe connected to the tee fitting, wherein the interior pipe directs oxygen downwardly; and
an exterior pipe surrounding the interior pipe, wherein the exterior pipe directs a mixture of oxygen and water upwardly.

20. The water treatment unit of claim 19, wherein the exterior pipe connects to a recirculation tee fitting to recirculate the mixture of oxygen and water within the water treatment unit.
